(19) United States
(12) Patent Application Publication
(10) Pub. No.: US 2015/0175467 A1
(43) Pub. Date: Jun. 25, 2015

(54) MOLD, METHOD FOR PRODUCING A MOLD, AND METHOD FOR FORMING A MOLD ARTICLE

(71) Applicant: Infineon Technologies Austria AG, Villach (AT)

(72) Inventors: Guenter Denifl, Annenheim (AT); Alexander Breymesser, Villach (AT); Markus Kahn, Rangersdorf (AT); Andre Brockmeier, Villach (AT)

(73) Assignee: Infineon Technologies Austria AG, Villach (AT)

(21) Appl. No.: 14/138,159

(22) Filed: Dec. 23, 2013

(51) Int. Cl. C03B 19/02; C03B 11/06

(52) U.S. Cl. CPC C03B 19/02; C03B 11/06; C03B 2215/50

(57) ABSTRACT

Various embodiments provide a mold including a pyrolytic carbon film disposed at a surface of the mold. Various embodiments relate to using a low pressure chemical vapor deposition process (LPCVD) or using a physical vapor deposition (PVD) process in order to form a pyrolytic carbon film at a surface of a mold.

### TECHNICAL FIELD

Various embodiments relate to a mold, a method for producing a mold, and a method for forming a mold article.

### BACKGROUND

Molds are used in various circumstances to produce objects from molding material. Molding material can be pressed into and against a mold in order to be shaped by the structure of the mold. In glass pressing applications, molten glass can be forcibly pressed into and against a glass mold in process to form glass structures, articles, objects, etc. However, molding material may not completely fill a mold, even under pressure and can adhere or stick to the mold. A mold may include an anti-sticking layer in order to mitigate such undesired effects. For example, an anti-sticking layer or anti-adhesive layer may be applied to a substrate of a mold. However some anti-sticking layers may not suitably adhere to the substrate of the mold or may coat the substrate non-uniformly in an unsatisfactory manner. Additionally, some anti-sticking layers may only be effective within a limited range of conditions related to pressure, temperature, and the like.

Therefore a robust anti-sticking layer that e.g., suitably coats a mold may be desired.

### SUMMARY

Various embodiments provide a mold including a pyrolytic carbon film deposited at a surface of the mold.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIGS. 1A-1C depict cross-sectional views of a mold;

FIG. 2 shows a cross-sectional view of an exemplary mold in accordance with various embodiments;

FIG. 3 shows an exemplary method for producing a mold in accordance with various embodiments;

FIGS. 4A-4C depict cross-sectional views of an exemplary mold in accordance with various embodiments;

FIGS. 5A-5B depict views of exemplary molds in accordance with various embodiments; and

FIG. 6 shows an exemplary method for forming a glass article in accordance with various embodiments.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments. Various embodiments are described in connection with methods and various embodiments are described in connection with devices. However, it may be understood that embodiments described in connection with methods may similarly apply to the devices, and vice versa.

The word “exemplary” is used herein to mean “serving as an example, instance, or illustration”. Any embodiment or design described herein as “exemplary” is not necessarily to be construed as preferred or advantageous over other embodiments or designs.

The terms “at least one” and “one or more” may be understood to include any integer number greater than or equal to one, i.e. one, two, three, four, etc.

The term “a plurality” may be understood to include any integer number greater than or equal to two, i.e. two, three, four, five, etc.

The word “over”, used herein to describe forming a feature, e.g. a layer, “over” a side or surface, may be used to mean that the feature, e.g. the layer, may be formed “directly on”, e.g. in direct contact with, the implied side or surface. The word “over”, used herein to describe forming a feature, e.g. a layer, “over” a side or surface, may be used to mean that the feature, e.g. the layer, may be formed “indirectly on” the implied side or surface with one or more additional layers being arranged between the implied side or surface and the formed layer.

The term “connection” may include both an indirect “connection” and a direct “connection”.

Exemplary embodiments described herein pertain to, without being limited to, methods for depositing pyrolytic carbon films as anti-sticking layer for molds, molds including pyrolytic carbon films as an anti-sticking layer, and methods for producing mold articles with molds having pyrolytic carbon films as an anti-sticking layer.

Pyrolytic carbon films can grow in a specific structural way e.g., with carbon rings that are in plane with the substrate surface. In principle, pyrolytic carbon films can have a nanocrystalline structure. In particular, carbon films formed through physical vapor deposition (PVD) are amorphous and can be annealed so as to form sp²-hybridized clusters containing aromatic carbon rings.

In accordance with exemplary embodiments herein molds may be made out of any suitable materials. In embodiments, the mold may be made, at least in part, of one or more crystalline materials. That is a mold may include a substrate such as, for example, a crystalline substrate (e.g., silicon substrate). The crystalline substrate of the mold may be patterned using conventional or known semiconductor manufacturing processes, such as, for example, material removal e.g., by etching, grinding, polishing, milling, or the like, and/or material deposition, to name a few. For example wet and/or dry etching methods may be implemented with respect to a silicon substrate to form a silicon mold structure. In general, the use of semiconductor manufacturing methods, including etching methods, may allow for precise formation of mold structures.

In exemplary embodiments, a mold can include at least one anti-sticking layer formed on or applied to the substrate so as to prevent or reduce the sticking or adherence of molding materials, e.g., molten glass, to the mold. In this regard, one or more of the surfaces of the mold substrate which come into contact with molding materials may be coated with an anti-sticking layer or anti-adhesive layer.

In exemplary embodiments, an anti-sticking layer can be formed on a mold substrate through, such as, a low pressure chemical vapor deposition process (LPCVD), a physical vapor deposition (PVD) process, or the like. For example, a LPCVD process can be implemented to form a pyrolytic carbon film on a mold substrate. The pyrolytic carbon film formed or deposited on the mold structure can act as an anti-sticking layer.

In exemplary embodiments, pyrolytic carbon films can be formed or deposited on a mold substrate in a conformal or substantially conformal fashion.

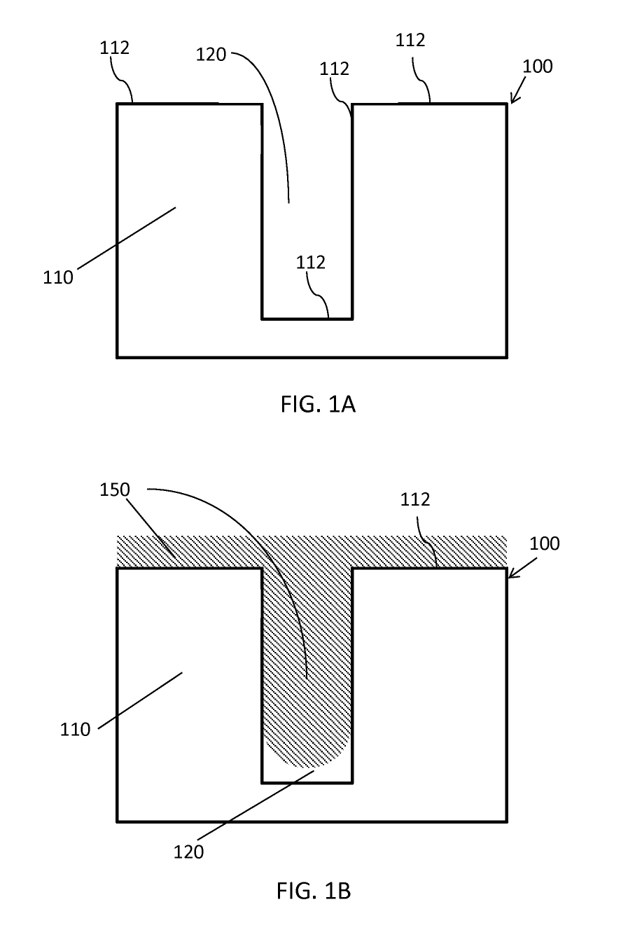

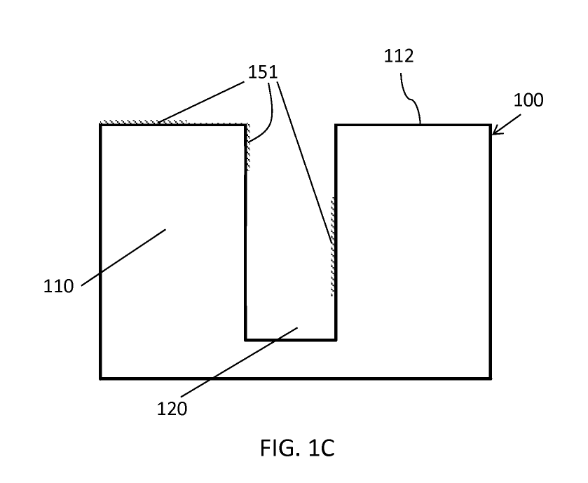

FIG. 1A shows a cross-sectional side view of a mold 100, or a section thereof. Molds such as the mold 100, can be used to shape molding materials into mold articles. In one example, the mold 100 may be used in glass pressing applications where molten glass can be pressed against and into the mold 100. Glass pressing processes can be used to form various glass articles, structures, objects, elements, and the like. In embodiments, the mold 100 may also be used with molding materials other than molten glass, such as heated/liquid plastic in one example.

In accordance with exemplary embodiments, the mold 100 includes at least a substrate 110 which can be made of any suitable materials, including crystalline materials (e.g., silicon), ceramic type materials, and the like. In cases where the substrate 110 is made of at least a semiconductor material, the substrate 110 can be patterned using known semiconductor manufacturing techniques/processes including, for example, deposition of layers, removal of layers by e.g., etching, grinding, and the like, to name a few. In embodiments, the substrate 110 can be made of materials designed to withstand high temperatures, pressures, or other conditions that the mold 100 may be subjected to during mold pressing.

Molds, such as the mold 100 may include openings, such as, for example, holes, trenches, and cavities, to name a few. As depicted in FIG. 1A, the mold 100 includes an opening 120. The mold 100 can include a mold surface 112, which can come into contact with a molding material, e.g., molten glass and the like, during pressing. The surface 112 may be the same material and may be integrally formed with the substrate 110, or may be made of different materials or layers formed separately. For example, in some embodiments the surface 112 can be formed by treating the patterned substrate 110 with one or more chemicals and/or by depositing one or more layers on the patterned substrate 110.

While the mold 100 depicted in FIG. 1A shows merely one opening, opening 120, this is merely exemplary. In various embodiments, the substrate 110 may vary and may include one or more additional openings, e.g., cavities, trenches, and/or one or more protrusions, e.g., bumps, ridges, etc., and/or include any other elements suitable for a pressing mold. In general, the mold 100 may have any suitable surface topology.

From the pressing of a molding material and a mold against each other, the various openings, e.g. trenches, cavities, and the like, may be partially or completely filled with the molding material. For example, FIG. 1B shows according to exemplary embodiments, a cross-sectional view of the mold 100 having a molding material 150 partially filling the opening 120. For brevity and clarity sake, various other conventional apparatuses, devices, and the like that could be used in pressing operations are omitted.

In embodiments, the molding material 150 can be molten glass, heated or liquid plastics, and/or other suitable molding material.

As shown in FIG. 1B, the molding material 150 does not completely fill the opening 120. Various factors may prevent the molding material 150 from satisfactorily filling up the opening 120 of the mold 100, such as, for example, the type of molding material 150, the size of the opening 120, materials making up the mold 100 and/or the mold surface 112, the amount of pressing force, and the like, to name a few. For example, the surface 112 may have defects (not shown) including having a non-uniform surface or having a surface roughness that prevents the molding material 150 from fully entering the opening 120. Additionally, the molding material 150 may not suitably fill up the opening 120 due to adhesion or affinity of the molding material 150 to the surface 112, and/or other factors.

Furthermore, the molding material 150 may stick at the surface 112 and may not be removed completely from the mold 100 after pressing due to this sticking, as is illustrated in the embodiment of FIG. 1C. As depicted in FIG. 1C, the remainders or residue of the molding material 150, which is designated 151, remains on the surface 112 of the mold 100 after the molding material 150 has been removed from the mold 100 after completion of the molding process.

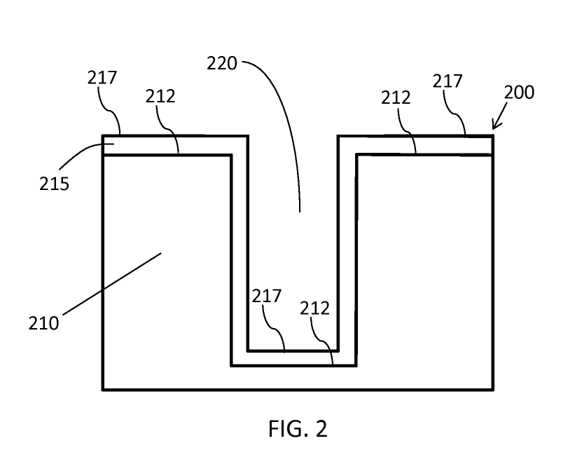

FIG. 2 shows according to exemplary embodiments, a cross-sectional side view of a representation of a mold 200, or a section thereof. The mold 200, like the mold 100 may also be used to shape molding materials into desired shapes and structures, and be used in glass pressing applications. The mold 200 may also be used to shape or press against molding materials such as molten glass, heated/liquid plastics, and/or any other suitable molding materials.

In accordance with exemplary embodiments, the mold 200 can include a mold substrate 210 which can be made of any suitable materials, including crystalline materials (e.g., silicon), ceramic type materials, and the like. In cases where one or more semiconductor materials are used, the substrate 210 can be patterned by applying known and/or appropriate semiconductor manufacturing techniques including, for example, deposition of layers, and/or removal of layers, e.g., by etching, grinding, etc., to a provided crystalline substrate.

As shown in FIG. 2, the mold 200 includes a pyrolytic carbon film 215. The carbon film 215 may be a LPCVD carbon film, a PVD carbon film, or the like. The pyrolytic carbon film 215 can be deposited or disposed over the substrate 210, such as for example, at least over a surface 212 of the substrate 210. The mold 200, like the mold 100, can include one or more openings, e.g., one or more holes, trenches, cavities, and/or one or more protrusions, bumps, etc. For example, in the embodiment of FIG. 2, the mold 200 includes an opening 220. The pyrolytic carbon film 215 can be disposed over or cover one or more walls of the opening 220, e.g., one or more sidewalls and/or a bottom wall of the opening 220.

In FIG. 2, the pyrolytic carbon film 215 can conformally coat the substrate 210, including conformally coating the opening 220. That is, the pyrolytic carbon film 215 can be formed over the surface 212 of the substrate 210 with uniform and/or substantially uniform step coverage.

In one or more embodiments, an adhesion layer may be disposed between the substrate 210 and the pyrolytic carbon film 215 to enhance adhesion of the carbon film 215 to the substrate 210.

In exemplary embodiments, pyrolytic LPCVD carbon films deposited on a patterned substrate can exhibit high conformity including on walls or surfaces of openings, e.g., holes, trenches, cavities, and/or steps, bumps, ridges, etc. For example, the pyrolytic carbon film 215 can be conformally deposited on or over the walls of the opening 220. In accordance with exemplary embodiments, the opening 220 can be a trench and may e.g., have an aspect ratio of up to about 20. In some embodiments, the opening 220 (e.g., trench) can have a width of about 50 μm to about 500 μm, and/or have a depth of about 50 μm to about 500 μm.

In accordance with exemplary embodiments, an outer surface 217 can be an exposed surface of the pyrolytic carbon film 215. The outer surface 217 can come into contact with molding materials. The surface 217 may come into contact with molding materials during mold pressing.

In accordance with exemplary embodiments, the pyrolytic carbon film 215 can have a thickness of less than or equal to about 1 μm, e.g., in the range of about 200 nm to 500 nm, or in the range of about 500 nm to about 1 μm. Further, the pyrolytic carbon film 215 can exhibit a polycrystalline and/or a nanocrystalline character, having, e.g., in cases of LPCVD carbon films, grain sizes in the ranges of, e.g., about 3 nm to about 20 nm, e.g., about 5 nm to about 10 nm. For example, the growth rates of exemplary pyrolytic LPCVD carbon films can be about 0.5 nm per minute to about 5 nm per minute.

In accordance with exemplary embodiments, the deposited pyrolytic LPCVD carbon film 215 may have low hydrogen content. For example, when the pyrolytic carbon film 215 is a LPCVD carbon film, it may have less than or equal to about 5% hydrogen content by atomic ratio (5 at %). Due to the low hydrogen content, pyrolytic LPCVD carbon films can have low shrinkage under thermal stress. For example, molds with a pyrolytic LPCVD carbon film can show no or minimal structural changes when post annealing had been carried out for temperatures up to about 1200° C. Thus effects, such as mechanical clamping of molding material pressed into the mold, may be prevented or avoided.

In embodiments, the pyrolytic carbon film 215 may have a relatively strong adhesion to the substrate 210. For example, in cases where a pyrolytic LPCVD carbon film is deposited on a patterned substrate made of semiconductor materials, e.g., silicon, the associated adhesion pull off values can be at least 20 MPa. Additionally, the pyrolytic LPCVD carbon film 215 can have low compressive stress, for example about −250 MPa.

In some exemplary embodiments, the pyrolytic carbon film 215 can be doped with silicon, boron, chromium, tungsten, titanium, tantalum, or combinations thereof, to increase the chemical resistance of the pyrolytic carbon film 215, e.g., to achieve a higher oxidation resistance.

In some exemplary embodiments, the pyrolytic carbon film 215 can include a halogen termination, such as, for example, a fluorine-terminated surface 217. Such halogen (e.g., fluorine) termination may, e.g., achieve a hydrophobic or superhydrophobic character of the film 215 (or surface 217), and may thus further reduce sticking of a molding material to the mold 200.

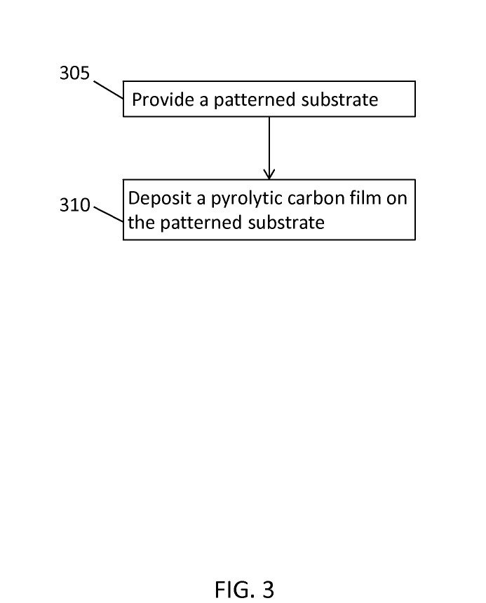

FIG. 3 shows an exemplary method for producing a mold, such as mold 200, in accordance with exemplary embodiments. In particular the method relates to producing a mold that includes a pyrolytic carbon film. In embodiments, the pyrolytic carbon film can act as an anti-sticking layer or anti-adhesive layer.

According to FIG. 3, at 305, a patterned substrate is provided. In embodiments, the patterned substrate can be provided in a deposition chamber. The deposition chamber may be any suitable deposition chamber. For example, the deposition chamber may be capable of implementing low pressure chemical vapor deposition (LPCVD) processes or procedures. In another example, the deposition chamber may be capable of implementing a physical vapor deposition (PVD) process or procedure. The patterned substrate, for example may be placed in the chamber through any suitable means.

At step 310, a pyrolytic carbon film is deposited on the patterned substrate, such as through low pressure chemical vapor deposition (LPCVD), physical vapor deposition (PVD), or the like.

In accordance with exemplary embodiments, the pyrolytic LPCVD carbon film can be deposited through low pressure chemical vapor deposition by directing a vapor that includes a carbon precursor onto the patterned substrate. In accordance with exemplary embodiments, the carbon precursor may be or may include, for example, ethane, acetylene, or methane, or any suitable hydrocarbon, to name a few.

In accordance with exemplary embodiments, in a LPCVD process, the vapor directed onto the provided mold substrate may include an inert gas. The inert gas may dilute the carbon precursor. The inert gas may be or may include, for example, nitrogen, helium, or argon, to name a few.

In accordance with exemplary embodiments, during vapor deposition through a LPCVD process, the carbon precursor, (e.g., ethane) may have a flow rate of about 200 sccm to about 5 slm, e.g., about 750 sccm to about 2 slm. The inert gas, (e.g., nitrogen gas), may have a flow rate of about 250 sccm to about 5 slm, e.g., about 1 slm to about 2.5 slm.

In accordance with exemplary embodiments, deposition temperatures of the vapor used in a LPCVD process may range from about 350° C. to about 950° C., e.g., from about 750° C. to about 900° C.

In accordance with exemplary embodiments, in a LPCVD process, the pyrolytic carbon film can be deposited onto the patterned substrate in the deposition chamber under a pressure of about 1 Torr to about 100 Torr, e.g., under a pressure of about 30 Torr to about 60 Torr.

In general, tetrahedral amorphous carbon films (ta-C) may be deposited through suitable physical vapor deposition (PVD) type methods, such as, for example, through pulsed-laser deposition (PLD), filtered cathodic vacuum arc (FCVA), etc. The ta-C obtained through such processes may be characterized as sp^{a}-diamond dominated and may be amorphous only for depositions carried out at temperatures less than about 200° C. At higher deposition temperatures, the sp³ content, optical gap, resistivity, stress and density can decrease while the roughness increases. In other words, the film can become sp²-graphite dominated.

At deposition temperatures greater than 200° C., the structural regime of ta-C can change or transform from a diamond-like structure to a graphite like structure. In one example, the deposition of carbon films by FCVA can yield films with a Tauc gap of approx. 2 eV and a resistivity of approx. 10⁸ Ωcm at room temperature deposition. However depositions carried out at approximately 450° C. can yield films with a Tauc gap of approx. 0.8 eV and a resistivity of as low as 1 Ωcm. Furthermore, at the higher deposition temperatures, the clustering of sp²-sites can cause the optical gap and the resistivity to fall. Annealing ta-C after deposition may also cause similar effects, although graphitization can occur at elevated temperatures greater than about 1100° C. Graphitic clusters in high temperature deposited carbon films may be oriented with their planes perpendicular to the film.

In exemplary embodiments, the patterned substrate may be formed from a crystalline substrate, such as, a silicon substrate, in one example.

In accordance with exemplary embodiments, the pyrolytic carbon film deposited on the patterned substrate can have a thickness of less than or equal to about 1 μm, e.g., in the range of about 200 nm to 500 nm, or in the range of about 500 nm to about 1 μm. Further, the deposited pyrolytic carbon films can exhibit a polycrystalline and/or a nanocrystalline character. For example, pyrolytic LPCVD carbon films may have grain sizes in the range of about 3 nm to about 20 nm, e.g., in the range of about 5 nm to about 10 nm. The growth rates of exemplary pyrolytic LPCVD carbon films can be about 0.5 nm per minute to about 5 nm per minute.

In accordance with exemplary embodiments, the deposited pyrolytic carbon films may have low hydrogen content. For example, a deposited pyrolytic LPCVD carbon film may have less than or equal to about 5% hydrogen content by atomic ratio (5 at %). Due to the low hydrogen content, the deposited pyrolytic carbon film can have low shrinkage under thermal stress. Molds with a pyrolytic carbon film can show no or minimal structural changes when post annealing had been carried out for temperatures up to about 1200° C. Thus effects, such as mechanical clamping of molding material pressed into the mold, may be prevented or avoided.

In embodiments, the pyrolytic carbon films may have a relatively strong adhesion to the patterned substrate. For example, in cases where the pyrolytic carbon film is deposited through a LPCVD process onto a patterned substrate made of semiconductor materials, such as silicon in particular, the associated adhesion pull off values can be at least 20 MPa. Additionally, a pyrolytic LPCVD carbon film may have low compressive stress, for example about −250 MPa.

A pyrolytic carbon film can have a hydrophobic surface and/or have low surface roughness. For example, a deposited pyrolytic LPCVD carbon film can have a surface roughness, expressed as arithmetic average to root mean square (Ra/Rq), of less than or equal to about 1 nm/1.2 nm. The surface roughness may be determined using atomic force microscopy (AFM) measurements with, for example, a scan range of 500×500 nm, using a carbon film thickness of about 500 nm. In some exemplary embodiments, the pyrolytic LPCVD carbon film may be doped with, for example, silicon, boron, and the like, and combinations thereof. The doping of a pyrolytic LPCVD carbon film can result in a higher chemical resistance, e.g., higher oxidation resistance to thermal stress, particularly during mold pressing.

Without being bound by theory, in some embodiments, a pyrolytic carbon films may be further processed to include a halogen termination (e.g., fluorine terminated surface). In one example, a pyrolytic LPCVD carbon film with halogen termination can exhibit super hydrophobic properties. In other words, such pyrolytic LPCVD carbon films can have improved hydrophobic properties and the degree or amount of sticking or adhesion to molding materials, such as molten hot glass, can be reduced and/or eliminated. For example, contact angle measurements with deionized water show plasma fluorine terminated surfaces of pyrolytic LPCVD carbon films to exhibit a contact angle of about 115°. In comparison, surfaces of pyrolytic LPCVD carbon films without plasma fluorine termination exhibit a contact angle of about 70°.

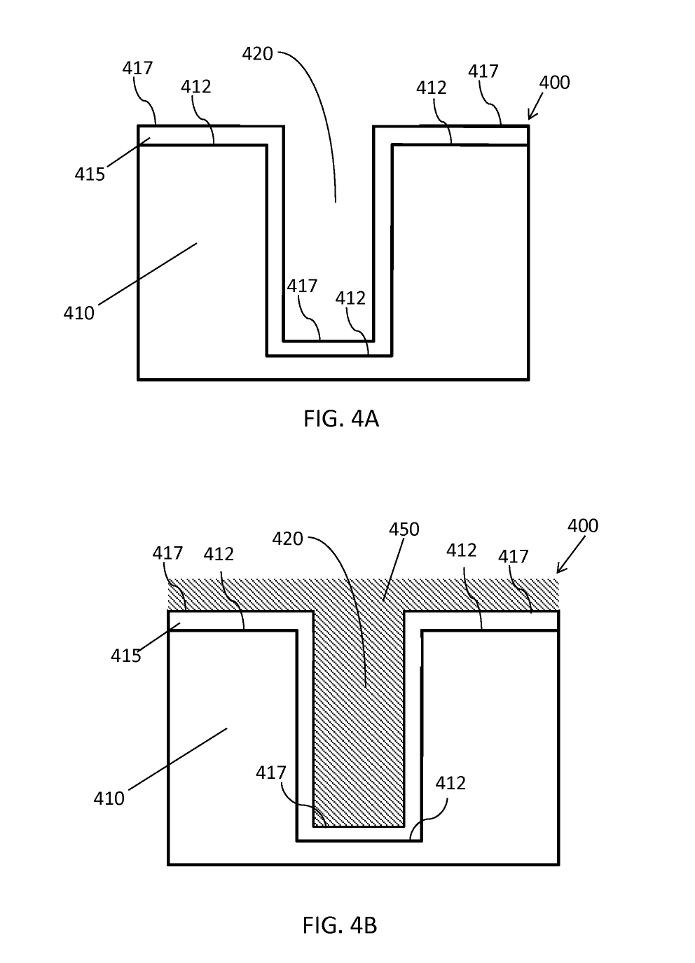

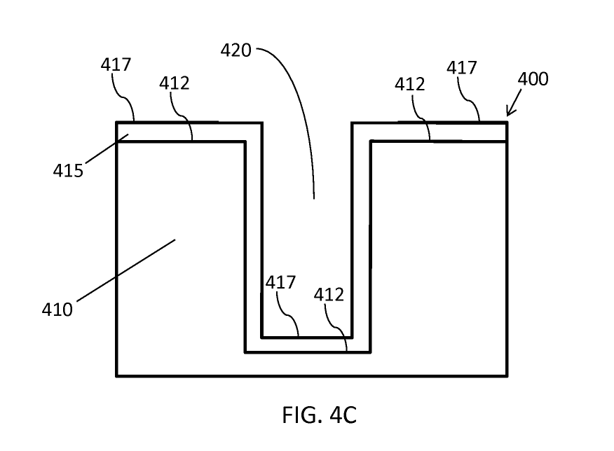

FIG. 4A shows according to exemplary embodiments, a cross-sectional side view of a representation of a mold 400, or a section thereof. The mold 400, like the mold 100 may also be used to shape molding materials into desired shapes and structures, and may e.g., be used in glass pressing applications. The mold 400 may also be used to shape or press against molding materials such as molten glass, heated/liquid plastics, and/or any other suitable molding materials.

In accordance with exemplary embodiments, the mold 400 can be substantially similar or the same as the mold 200 of FIG. 2. That is, in accordance with exemplary embodiments, the mold 400 can include a mold substrate 410 which can be made of any suitable materials, including crystalline materials (e.g., silicon), ceramic type materials, and the like. With respect to crystalline materials, the substrate 410 can be formed or patterned by applying known and/or appropriate semiconductor manufacturing techniques including, for example, deposition of layers, removal of layers, e.g., by etching, grinding, polishing, milling, etc., to a provided crystalline substrate.

As shown in FIG. 4A, the mold 400 includes a pyrolytic carbon film 415. The pyrolytic carbon film 415 can be deposited or formed for example, at least at a surface 412 of the substrate 410. The pyrolytic carbon film 415 can be deposited through any suitable method, such as through low pressure chemical vapor deposition, physical vapor deposition, or the like. The mold 400, like the mold 200, can include one or more openings, e.g., one or more holes, trenches, cavities, and/or one or more protrusions, e.g. bumps, ridges, etc. For example, in the embodiment of FIG. 4A, the mold 400 includes an opening 420.

As shown in FIG. 4A, the pyrolytic carbon film 415 can conformally coat the substrate 410. As shown, the pyrolytic carbon film 415 can be formed over and on the surface 412 of the substrate 410 with uniform and/or substantially uniform step coverage, including high uniformity or step coverage in the opening 420. That is, the pyrolytic carbon film 415 can be conformally formed or deposited on or over the wall or walls (e.g., sidewalls and bottom wall) of the opening 420. In accordance with exemplary embodiments, the opening 420 can have an aspect ratio of up to about 20. In one or more embodiments, the opening 420 can have a width of about 50 μm to about 500 μm, and/or have a depth of about 50 μm to about 500 μm. In other embodiments, the aspect ratio and/or width and/or depth may have other values.

In accordance with exemplary embodiments, an outer surface 417 can be an exposed surface of the pyrolytic carbon film 415. The outer surface 417 of the film 415 can come into contact with molding materials. For example, the surface 417 may come into contact with molding materials during mold pressing.

FIG. 4B shows according to exemplary embodiments, a cross-sectional side view of the mold 400 and a molding material 450. For brevity and clarity sake, other apparatuses, devices, elements, and the like that may be used in mold pressing are not shown.

The mold 400 may be pressed against the molding material 450, and/or vice versa. The molding material 450 can be for example, molten glass, heated or liquid plastics, and/or other suitable molding material. In embodiments where the molding material 450 is a molten glass, the molten glass can have a temperature of about 350° C. to about 800° C.

In some exemplary embodiments, the molding material 450 may be a curable material. In this regard, the opening 420 can be filled with a curable material and thereafter cured. Curable materials that may be used in forming a mold article can include, for example, thermosetting materials, photo curable materials, and the like. Such curable materials may be cured by the application of heat, or application of radiation e.g., UV radiation.

As shown in the embodiment of FIG. 4B, the opening 420 is now completely or substantially filled with the molding material 450.

In exemplary embodiments, the molding material 450 may be removed or separated from the mold. The molding material 450 may be removed from the mold 400 after the molding material has settled, hardened, cured, and/or cooled. In removing or separating the molding material 450 from the mold 400, none or a negligible amount of the molding material 450 may remain in and/or attached to the mold 400, as illustrated in FIG. 4C.

In embodiments, the molding material 450 and the mold 400 can be pressed against one another. In this regard, a pressing force of 20 kN or less can be applied. The pressing may take place or be implemented under vacuum or inert atmospheric type conditions.

In accordance with exemplary embodiments, a process of pressing a molding material and a mold against one another, allowing the molding material to settle, harden, cure, and/or cool, and then removing the molding material from the mold may be repeated a number of times, or as is necessary to form a mold article.

In accordance with exemplary embodiments, molds, such as molds described herein including pyrolytic carbon films may vary in shape and/or structure. For example, openings, e.g., trenches, cavities, etc., and/or protrusions, and the like, of such molds can also vary in shape and/or size. For example, such molds can have openings different and/or more complex than the opening 420 depicted with respect to the mold 400.

In some embodiments, the openings or the like may not have walls that are perpendicular to the surface of the mold substrate. For example, one or more walls of an opening, trench, etc. may taper. In such cases, the width of the opening, trench, etc. can be greater at one end, e.g., at the surface of the substrate, and be narrower at the bottom of the opening, trench, etc. In some embodiments, the walls of openings, trenches, etc. may be curved, at least in part.

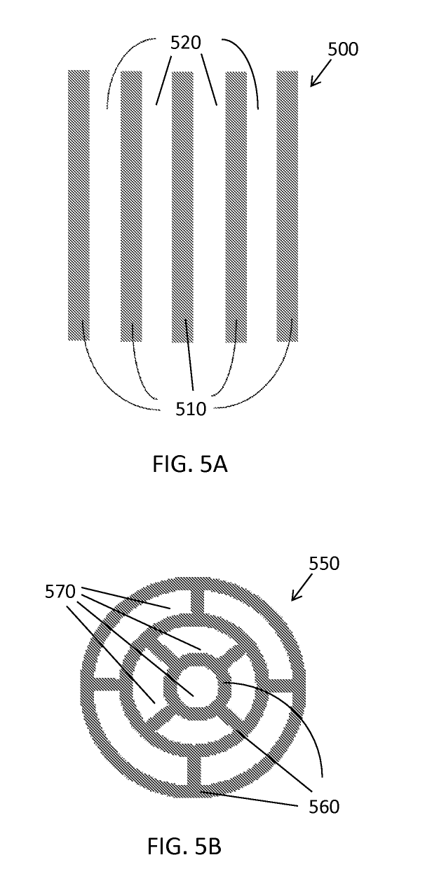

In some embodiments, molds can be characterized as open and/or self-contained structures. For example, FIG. 5A shows a top view of a mold 500 with an open structure. As shown, the mold 500 includes a series of openings 510 that are open, or not enclosed or self-contained. For example, the openings 510 may be trenches in a substrate 520, as shown.

In another example, FIG. 5B shows a top cross-sectional view of a mold 550 with a closed structure. The mold 550 has openings 560 which are self-contained or enclosed. The openings 560 may, for example, be formed in a substrate 570, as shown. In embodiments, molds can have a combination of enclosed and open openings, e.g., trenches, cavities, etc. As mentioned, pyrolytic carbon films may be formed and disposed conformally on such molds (e.g., through a LPCVD process, a PVD process, etc.), including on the wall or walls of the openings, cavities, trenches, holes, protrusions, bumps, etc.

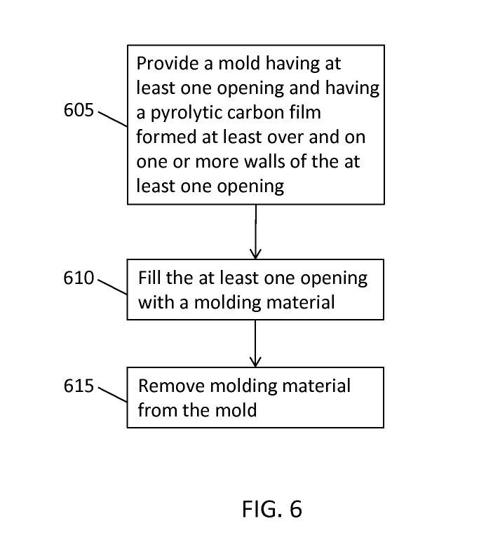

FIG. 6 shows an exemplary process for forming a mold article. At step 605, a mold is provided having at least one opening and having a pyrolytic carbon film formed at least over one or more walls of the at least one opening. The pyrolytic carbon film can be formed in accordance with embodiments herein, e.g., by a LPCVD process, a PVD process, etc.

The mold can include a patterned substrate, for example, a patterned crystalline substrate. A patterned crystalline substrate can be formed from a semiconductor workpiece (e.g., wafer) using any suitable semiconductor manufacturing processes.

The pyrolytic carbon film can act as anti-sticking layer or anti-adhesive layer, and may coat or cover in a conformal or substantially conformal manner, the one or more walls of the at least one opening. Other surfaces of the mold can also be covered by the pyrolytic carbon film.

In FIG. 6, after providing the mold, a molding material can fill the at least one opening at 610. In accordance with exemplary embodiments, the molding material can be pressed against the mold, and/or the mold can be pressed against the molding material so that the molding material fills the at least one opening. In some embodiments, the pressing may be repeated so that the molding material satisfactorily enters and fills the at least one opening. A pressing force of less than or equal to 20 kN may be used in accordance with one or more embodiments.

The molding material may be a material, such as molten glass, heated or liquid plastic, and the like. At 615 the molding material may be removed from the mold. The molding material may be removed after the molding material has at least partially cooled, settled, cured, and/or hardened in the mold.

In the following, various aspects and potential effects of one or more embodiments are described:

In accordance with exemplary embodiments, the disclosure relates to the deposition of pyrolytic carbon films on mold structures. The pyrolytic carbon films may be deposited through a low pressure chemical vapor deposition (LPCVD) process, a physical vapor deposition process, or the like. The mold structures can be etched via dry or wet chemical etching methods. The carbon coated structures can act as an anti-sticking and protection layer in hot glass pressing applications, and thus enabling repeated glass pressing process. For example, the use of uncoated silicon mold structures for glass pressing can result in severe sticking of the glass melt. Therefore an anti-sticking layer may be required to enable multiple or repeated glass pressing procedures. Thus, due to the physical and chemical properties of carbon one highly interesting film for such applications can be pyrolytic carbon.

In accordance with exemplary embodiments, during glass pressing conditions the pyrolytic LPCVD carbon films or the like may need to withstand temperatures up to about 800° C. with: (i) good adhesion on the structured silicon substrate, (ii) high thermal robustness, especially low shrinkage and low out-gasing (low hydrogen content), and (iii) low sticking behavior to the ductile glass melt during the pressing process and removal of the cooled down glass melt from the mold. Advantages of pyrolytic LPCVD carbon films can include highly uniform step coverage and film conformity in trench structures in comparison to other films, such as Plasma-Enhanced Chemical Vapor Deposited (PE-CVD) deposited carbon films.

Pyrolytic LPCVD carbon films may be used in lieu of other carbon films, such as tetrahedral amorphous carbon films (ta-C). Highly thermally durable tetrahedral amorphous carbon films (ta-C) exist that exhibit a high value of compressive stress up to −10 GPa. However pyrolytic LPCVD carbon films may be better suited as anti-sticking layer since pyrolytic carbon can have better adhesion to substrates (ta-C can have low adhesions on a substrate during cyclic stress conditions) and a better or faster deposition rate (ta-C can have a low deposition rate, e.g., about a few nm per minute). Ta—C films may also exhibit low shrinkage and hydrogen content, and can withstand temperatures of as high as 1100° C. under vacuum. However, due to the deposition mechanism, pyrolytic LPCVD carbon films may exhibit better edge coverage than ta-C films, particularly in regards to edge coverage and conformity in trench or trench-like structures. Thus, ta-C films may not be as suitable for coating glass pressing molds with trench structures, (e.g., structures with openings) in comparison to pyrolytic LPCVD carbon films.

Besides ta-C films, another possibility for anti-sticking layer are conventional PE-CVD carbon based films. PE-CVD may have more limited temperature stability in comparison to pyrolytic LPCVD carbon films. Due to chemical reasons, PE-CVD carbon based films always contain hydrogen to a certain amount (typically up to about 30-40 at %). The greater presence of hydrogen in PE-CVD films, as opposed to pyrolytic LPCVD carbon films, can limit the efficacy of these classes of carbon films for coating molds for glass pressing applications. During glass pressing process, hydrogen from the PE-CVD films can be released, which in turn results in bubbles formed in a cooled down glass melt. Further, PE-CVD carbon films, unlike pyrolytic LPCVD carbon films, can have strong shrinkage and produce subsequent structural and morphological damage. Peeling of the PE-CVD carbon film may occur by the release of hydrogen and by the physical stress induced by elevated temperatures of about ≧500° C.

Some PE-CVD carbon based films having high temperature stability and low shrinkage are known, and could be deposited by adding a diluting gas to a hydrocarbon precursor (e.g., N₂, He, Ar, etc.) in combination with a strong ion-bombardment at high plasma generator power and low deposition pressure. These films could be stabilized with post annealing steps. However, these films, unlike pyrolytic LPCVD carbon films, may be limited and have a highly non-conformal step coverage and low trench conformity due to their deposition mechanism.

Pyrolytic LPCVD carbon films can be deposited with a carbon precursor (e.g. Ethene, Acetylene, Methane, or any suitable hydrocarbon) diluted in e.g., nitrogen at temperatures from about 600° C. up to 950° C. These carbon films can exhibit polycrystalline character with grain sizes in the region of a few nm up to about 20 nm. The growth rate can range typically from around 0.5 up to about 5 nm per minute, with typical film thicknesses of up to 1 μm. These carbon films exhibit very low hydrogen content (e.g., about 5 at %) and therefore may exhibit low shrinkage at temperatures up to 1000° C. Almost no structural changes, during post annealing steps up to 1200° C., were observed (graphitic film character). Hydrophobic surface properties, low stress (about −250 MPa compressive) and very good adhesion to silicon substrates (pull off adhesion values higher than about 20 MPa where observed) are characteristic for such pyrolytic carbon films. Typical silicon molds can exhibit self-contained or open trench structures with a broadness of 50 μm to 500 μm or even more and a depth of 50 μm to several 100 μm. During a glass pressing process, molten glass may be pressed under a force of up to 20 kN in the mold under vacuum or inert conditions, and thus the carbon film is not ashed by oxygen residues. Boron or silicon-doping can be used to increase the chemical resistance of the carbon based anti-sticking film.

Highly uniform step coverage can be desired and/or mandatory for coating silicon molds. Geometrically complex structures may need to be coated homogeneously and free of defects. Deposition methods implemented with an almost unidirectional stream of ions and neutrals can fail to uniformly coat complex structures. A carbon LPCVD film may be able to geometrically coat complex structures due to the temperature driven deposition mechanism, and thus can avoid any unidirectional coating stream.

Trenches of molds having aspect ratios of about 20 can be coated with high conformity by these pyrolytic LPCVD carbon films. Further these carbon films can have a very low roughness due to their nanocrystalline character (grain size of about 5-10 nm). They may also exhibit low affinity to glass melt which enables a desirable and suitable releasing of the cooled down glass melt from the carbon coated mold. Cyclic pressing processes can be enabled because of the high quality of the film adhesion of the pyrolytic LPCVD carbon films on the silicon mold.

In exemplary embodiments, a pyrolytic LPCVD carbon film deposited onto contact surfaces of a silicon mold can have a film thickness of about 1 micron or less, (typically between 200 nm to 500 nm) with a polycrystalline graphitic structure. The pyrolytic LPCVD carbon film can exhibit uniform step coverage and high conformity in deep mold structures. The pyrolytic LPCVD carbon film can exhibit good adhesion to a silicon substrate, low shrinkage at thermal stress (low hydrogen content) and low tendency to stick with the hot molten glass during the pressing process (glass temperature about 350-800° C., pressing force up to 20 kN, under vacuum or inert atmosphere). These characteristics can enable repeated glass pressing processes by using an identical mold.

The anti-sticking carbon based film (e.g., a pyrolytic LPCVD carbon film) could be doped with silicon or boron to achieve a higher oxidation resistance during the pressing glass process. A fluorine termination of the surface can be implemented to give the film a super hydrophobic character and therefore to reduce the sticking to a hot glass melt. Contact angle measurements of a plasma fluorine terminated pyrolytic surface showed a contact angle with deionized water of about 115 degree (in comparison a not terminated carbon surface exhibits a contact angle of about 70 degree).

Pyrolytic LPCVD carbon films may have advantages over other types of carbon films, such as PE-CVD carbon films by having better conformal step coverage, and a high conformity in trench structures. The pyrolytic LPCVD carbon films show low shrinkage, and thus may not have structural damage by contact with hot glass melt, in comparison to conventional PE-CVD carbon films which can show high shrinkage and structural damage by contact with the hot glass melt (film delamination and bubbles in the pressed glass occur).

In accordance with exemplary embodiments, molds with pyrolytic carbon films may be used in Microelectromechanical systems (MEMS) applications. For example molds with pyrolytic carbon film may be used to manufacture one or more components for a MEMS device, including, glass components. In various MEMS structures, glass can act as a major integrative part. In this regard glass components or parts for MEMS devices may need to be structured so as to form, for example, cavities, holes, etc. This may be accomplished through methods such as, for example, wet chemical etching, polishing, grinding and the like. However, glass hot embossing with the use of mold with pyrolytic carbon films can provide a method to structure glass which can be consecutively part of a MEMS device or structure. For example, a mold (e.g., having a negative shape) can be coated by the previous described pyrolytic carbon film layer having anti-sticking behavior. In this regard, the negative shape of the mold can be transferred to form a corresponding positive structure in the glass by glass hot embossing. The coated mold can be reused as is appropriate.

In accordance with exemplary embodiments, molds with pyrolytic carbon films may be used in furnace related applications.

In accordance with exemplary embodiments, molds with pyrolytic carbon films may be used in optical glass applications.

One or more exemplary embodiments relate to a mold including a pyrolytic carbon film disposed at a surface of the mold.

In accordance with exemplary embodiments, the mold includes a patterned substrate, wherein the pyrolytic carbon film is disposed over the patterned substrate.

In accordance with exemplary embodiments, the patterned substrate includes at least one opening, and the pyrolytic carbon film is disposed over one or more walls of the at least one opening.

In accordance with exemplary embodiments, the pyrolytic carbon film conformally coats the one or more walls of the at least one opening.

In accordance with exemplary embodiments, the at least one opening has an aspect ratio greater than or equal to 20.

In accordance with exemplary embodiments, the at least one opening has a depth of greater than or equal to about 50 μm.

In accordance with exemplary embodiments, the at least one opening has a depth of about 50 μm to about 100 μm.

In accordance with exemplary embodiments, the at least one opening includes at least one trench.

In accordance with exemplary embodiments, the at least one opening has a width of about 50 μm to about 500 μm.

In accordance with exemplary embodiments, the pyrolytic carbon film has a thickness of less than or equal to about 1 μm.

In accordance with exemplary embodiments, the pyrolytic carbon film has a thickness of about 200 nm to about 500 nm.

In accordance with exemplary embodiments, the pyrolytic carbon film comprises about 5% hydrogen content by atomic ratio.

In accordance with exemplary embodiments, the pyrolytic carbon film is doped with a dopant selected from the following group: silicon, boron, chromium, tungsten, titanium, tantalum, and combinations thereof.

In accordance with exemplary embodiments, the patterned substrate includes a crystalline material.

In accordance with exemplary embodiments, the pyrolytic carbon film comprises a halogen termination.

In accordance with exemplary embodiments, the pyrolytic carbon film comprises a physical vapor deposition (PVD) carbon film.

In accordance with exemplary embodiments, the pyrolytic carbon film comprises a low pressure chemical vapor deposition (LPCVD) carbon film.

One or more exemplary embodiments relate to a method for producing a mold, the method including: providing a patterned substrate; and depositing a pyrolytic carbon film on the patterned substrate.

In accordance with exemplary embodiments, depositing the pyrolytic carbon film includes depositing the pyrolytic carbon film through low pressure chemical vapor deposition (LPCVD).

In accordance with exemplary embodiments, depositing the pyrolytic carbon film includes directing a vapor including a carbon precursor onto the patterned substrate.

In accordance with exemplary embodiments, the carbon precursor includes a hydrocarbon, such as ethane, acetylene, or methane and the like.

In accordance with exemplary embodiments, the vapor further includes an inert gas. In embodiments, the inert gas dilutes the carbon precursor.

In accordance with exemplary embodiments, the inert gas includes a gas selected from the group consisting of nitrogen, helium, and argon.

In accordance with exemplary embodiments, the vapor has a deposition temperature of about 350° C. to about 950° C.

In accordance with exemplary embodiments, the vapor has a deposition temperature of about 750° C. to about 900° C.

In accordance with exemplary embodiments, the pyrolytic carbon film is deposited on the mold in a deposition chamber under a pressure of about 1 Torr to about 100 Torr.

In accordance with exemplary embodiments, the pyrolytic carbon film is deposited on the mold in a deposition chamber under a pressure of about 30 Torr to about 60 Torr.

In accordance with exemplary embodiments, the patterned substrate is a patterned crystalline substrate.

In accordance with exemplary embodiments, the patterned substrate includes at least one opening.

In accordance with exemplary embodiments, depositing the pyrolytic carbon film includes depositing the pyrolytic carbon film through physical vapor deposition (PVD).

In accordance with exemplary embodiments, the method for producing the mold can further include annealing at least the pyrolytic carbon film.

One or more exemplary embodiments relate to a method for forming a mold article, the method including: providing a mold having at least one opening and having a pyrolytic carbon film formed at least over one or more walls of the at least one opening; filling the at least one opening with a molding material; and removing the molding material from the mold.

In accordance with exemplary embodiments, the molding material completely fills the at least one opening.

In accordance with exemplary embodiments, filling the at least one opening with the molding material includes pressing the molding material against the mold and/or pressing the mold against the molding material.

In accordance with exemplary embodiments, the molding material is pressed with a force less than or equal to 20 kN.

In accordance with exemplary embodiments, the molding material is molten glass.

In accordance with exemplary embodiments, the molten glass has a temperature of about 350° C. to about 800° C.

In accordance with exemplary embodiments, the pyrolytic carbon film has a thickness less than or equal to about 1 μm.

In accordance with exemplary embodiments, the pyrolytic carbon film has a thickness of about 200 nm to about 500 nm.

In accordance with exemplary embodiments, the pyrolytic carbon film comprises about 5% hydrogen content by atomic ratio.

In accordance with exemplary embodiments, the at least one opening has an aspect ratio of greater than or equal to 20.

In accordance with exemplary embodiments, the at least one opening has a depth of greater than or equal to 50 μm.

In accordance with exemplary embodiments, the at least one opening has a depth of about 50 μm to about 100 μm.

In accordance with exemplary embodiments, the at least one opening has a width of about 50 μm to about 500 μm.

In accordance with exemplary embodiments, the mold includes a patterned silicon substrate.

In accordance with exemplary embodiments, filling the at least one opening with the molding material includes filling the at least one opening with a curable material and subsequently curing the curable material.

In accordance with exemplary embodiments, the curable material includes at least one of: a thermosetting material, and a photo curable material.

In accordance with exemplary embodiments, the pyrolytic carbon film is a low pressure chemical vapor deposition (LPCVD) carbon film.

In accordance with exemplary embodiments, the pyrolytic carbon film is a physical vapor deposition (PVD) carbon film.

One or more exemplary embodiments relate to a method for producing a mold, the method including: providing a patterned substrate; depositing a pyrolytic carbon film on the patterned substrate through physical vapor deposition (PVD); and annealing at least the pyrolytic carbon film.

In accordance with exemplary embodiments, after annealing, the pyrolytic carbon film has a polycrystalline structure.

While various aspects of this disclosure have been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

What is claimed is:

1. A mold, comprising a pyrolytic carbon film disposed at a surface of the mold.

2. The mold of claim 1, further comprising a patterned substrate, wherein the pyrolytic carbon film is disposed over the patterned substrate.

3. The mold of claim 2, wherein the patterned substrate comprises at least one opening, and wherein the pyrolytic carbon film is disposed over one or more walls of the at least one opening.

4. The mold of claim 3, wherein the pyrolytic carbon film conformally coats the one or more walls of the at least one opening.

5. The mold of claim 3, wherein the at least one opening has an aspect ratio greater than or equal to 20.

6. The mold of claim 1, wherein the pyrolytic carbon film has a thickness of less than or equal to about 1 μm.

7. The mold of claim 1, wherein the pyrolytic carbon film is doped with a dopant selected from the following group: silicon, boron, chromium, tungsten, titanium, tantalum, and combinations thereof.

8. The mold of claim 2, wherein the patterned substrate comprises a crystalline material.

9. The method of claim 1, wherein a surface of the pyrolytic carbon film comprises a halogen termination.

10. The method of claim 1, wherein the pyrolytic carbon film comprises a low pressure chemical vapor deposition (LPCVD) carbon film.

11. The method of claim 1, wherein the pyrolytic carbon film comprises a physical vapor deposition (PVD) carbon film.

12. A method for producing a mold, the method comprising:
providing a patterned substrate; and
depositing a pyrolytic carbon film on the patterned substrate.

13. The method of claim 12, wherein depositing the pyrolytic carbon film comprises depositing the pyrolytic carbon film through low pressure chemical vapor deposition (LPCVD).

14. The method of claim 13, wherein depositing the pyrolytic carbon film comprises directing a vapor comprising a carbon precursor onto the patterned substrate.

15. The method of claim 14, wherein the carbon precursor comprises a hydrocarbon.

16. The method of claim 14, wherein the vapor further comprises an inert gas.

17. The method of claim 14, wherein the vapor has a temperature of about 350° C. to about 950° C.

18. The method of claim 13, wherein the pyrolytic carbon film is deposited on the mold in a deposition chamber under a pressure of about 1 Torr to about 100 Torr.

19. The method of claim 12, wherein depositing the pyrolytic carbon film comprises depositing the pyrolytic carbon film through physical vapor deposition (PVD).

20. The method of claim 19, further comprising annealing at least the pyrolytic carbon film.

21. A method for forming a mold article, the method comprising:
providing a mold having at least one opening and having a pyrolytic carbon film formed at least over one or more walls of the at least one opening;
filling the at least one opening with a molding material; and
removing the molding material from the mold.

22. The method of claim 21, wherein filling the at least one opening with the molding material comprises at least one of pressing the molding material against the mold and pressing the mold against the molding material.

23. The method of claim 21, wherein the molding material is molten glass.

24. The method of claim 21, wherein the pyrolytic carbon film has a thickness of less than or equal to about 1 μm.

25. The method of claim 21, wherein filling the at least one opening with the molding material comprises filling the at least one opening with a curable material and subsequently curing the curable material.

26. The method of claim 21, wherein the pyrolytic carbon film comprises a low pressure chemical vapor deposition (LPCVD) carbon film.

27. The method of claim 21, wherein the pyrolytic carbon film comprises a physical vapor deposition (PVD) carbon film.
